(19) United States
(12) Patent Application Publication
(10) Pub. No.: US 2002/0013781 A1
(43) Pub. Date: Jan. 31, 2002

(54) System and method of searchin and gathering information on-line and off-line

(76) Inventor: Erik Petersen, Providence, RI (US)

Correspondence Address: Kevin R. Spivak, Morrison & Foerster LLP, Suite 5500, 2000 Pennsylvanis Avenue, N.W., Washington, DC, 20006-1888, US

(21) Appl. No.: 09/758,357

(22) Filed: Jan. 12, 2001

Related U.S. Application Data
(60) Provisional application No. 60/175,960, filed on Jan. 13, 2000.

(51) Int. Cl. G06F 17/30

(52) U.S. Cl. 707/10

(57) ABSTRACT

A system and method of searching using a network by gathering information off-line. Data is collected from users that do not have on-line capability, to place the data on-line. Alternatively, users that can not access data on-line are give the ability to such data via an intermediary or third party.

### CLAIM OF PRIORITY

This application claims the benefit of priority from provisional application Ser. No. 60/175,960, filed Jan. 13, 2000, which is hereby incorporated by reference.

### TECHNICAL FIELD OF THE INVENTION

The present invention relates to a system, method and medium of searching using a network, and in particular, to a system, method and medium of searching off-line by gathering information on-line.

### BACKGROUND OF THE INVENTION

People collect, search for, purchase and sell everything on-line in today's society. Everything from antiques to architectural details to art to classic cars and fine objects is searched for on-line. However, even with the onslaught of on-line retail, some objects and information still remain difficult to locate. For example, if someone is in search of a rare eighteenth century pen, it will likely be difficult, if not impossible, to locate such an object on-line. This is so because people have traditionally gathered at physical places of business ranging from specialty stores to flee markets and garage sales in order to find, in particular, rare objects and oddities. These places of business (e.g. retailers/vendors/merchants) often travel around the world displaying their rare finds in search of the perfect consumer/buyer. While these retailers often have a vast supply of objects and information, they often do not have the means to either inform people of their supply or the knowledge of what consumers/buyers are interested in purchasing/collecting other than those consumers that they are physically in contact with. Hence, a need exists to gather information in a convenient location for retailers and consumers alike in order to expedite the needs of consumers and expand the consumer base to retailers.

### SUMMARY OF THE INVENTION

In one embodiment of the invention, there is a method of gathering data on-line for use off-line. The method includes, for example, collecting data from users off-line and storing the data in a storage unit and sending the data collected off-line to users on-line.

In one aspect of the invention, data is collected from a web page accessible by the users on-line, and data sent to the users off-line is manipulated before sending such that the data conforms to a device receiving the data.

In another embodiment of the invention, there is a method of communicating data to users off-line using the data stored on-line. The method includes, for example, storing data in a database, and delivering the data stored in the database to users, such that the users receive the information without going on-line to access the database.

In one aspect of the invention, the data includes a request for an item to be submitted to a vender off-line.

In another aspect of the invention, the method further includes manipulating the data to place it in a format conforming to a device receiving the data.

In still another embodiment of the invention, there is a method of searching for an object using a intermediary. The method includes, for example, providing an interface for a user to request the objects, and sending the request to users off-line, enabling the users off-line to search for the requested objects.

In one aspect of the invention, the method further includes, for example, storing the request in a database, selecting users to send the data to based on the requested data and notifying the user on-line of the results of the search. Selecting includes, for example, correlating data based on category and business type information.

In yet another embodiment of the invention, there is a method of shopping on-line using retailers/vendors off-line. The method includes, for example, searching a database including data having user requests stored therein and sending the data, manipulated to conform with a receiving device, such that a search based on the user requests is conducted by a selected retailer/vendor.

In one aspect of the invention, the method further includes, for example, forwarding results of the search for posting on-line.

In still another embodiment of the invention, there is a system for gathering data on-line for use off-line. The system includes, for example, a database collecting data from users off-line and a server accessing the data in the database and sending the data to users on-line.

In yet another embodiment of the invention, there is a system for shopping on-line using retailers/vendors off-line. The system includes, for example, a database storing data including user requests and retailers/vendors, a server matching the user requests and retailers/vendors data, and sending the user request to the matched retailers/vendors such that a search based on the user requests is conducted by a selected retailers/vendors.

In one aspect of the invention, the results of the search by the retailers/vendors are posted on-line.

### BRIEF DESCRIPTION OF THE DRAWINGS

FIG. 1 is an exemplary diagram of the system in the present invention.

FIG. 2 is an exemplary web page for a members sign-in page.

FIG. 3 illustrates a web page to update member accounts.

FIG. 4 is an exemplary diagram of a web page to administer an account.

FIG. 4a is an exemplary diagram of a web page to administer and account.

FIG. 5 is an exemplary diagram of a web page to classify an item.

FIG. 5a is an exemplary diagram of a web page to classify an item.

FIG. 6 illustrates an exemplary request from a user.

FIG. 7 is an exemplary flow diagram of gathering and broadcasting information.

### DETAILED DESCRIPTION OF THE INVENTION

The invention allows users (e.g. consumers and vendors/merchants) that do not have on-line capability to sell or post objects and/or information on-line, without ever getting on-line. That is, users can post objects and/or information that is stored or located at the user's off-line location/site, by using an intermediary on-line service. The invention also enables users to search and/or purchase objects and/or information on-line from vendors/merchants that do not have on-line capability. That is, users can search for objects and/or information that are stored or located on-line, by using an intermediary on-line service. Searching can be conducted on multiple databases, and is not limited to information acquired from the present invention itself. That is, searches performed using information or objects stored in the database of the present invention may be augmented by searches conducted on other databases, as readily understood by one having ordinary skill in the art.

Objects and information, for example a piece of antique furniture sold at flea market, that are not accessible on, for example, a network can be gathered and stored in, for example, a database accessible by the network. Objects and information stored in the database can then be retrieved by searching the database of information via a service accessible on the network. For example, a web store may be stored in a server that is accessible by consumers in order to view the database of information.

The system, in various embodiments, utilizes input values from (off-line and on-line) buyers and inserts the values into scripting code variables such that custom search bots, or “spiders”, can be enabled. Then the system spider searches the network (e.g. Internet), as well as databases, for objects for sale that meet the requirements and specifications indicated by the buyer (i.e. user). The spider can be made intelligent by focusing on, and learning from its past successes. For example, if a search object is “book+first edition+Melville”, then limit indexing search to sites found in data table “books_rare”. A table representing past successes of previous similar searches is used and updated. Therefore, the bot can learn through keeping track, via a database, of past success and failures. Hence, the more the “bot” searches, the more knowledgeable the “bot” becomes.

More specifically, consumers (e.g. an individual in search of a specific item) can search for an item on-line that is located with an “off-line” retailer (i.e. merchant). In doing so, a consumer can access the database of information that has been created as a result of relationships previously formed with vendors. If the database of information does not already include information relating to the specified item (e.g. which vendor may be contacted in order to locate the item), vendors may be contacted via the service. Vendors can then supply the database with information relating to the desired item. Alternatively, vendors can come to the site and search to determine what, if any, items are being sought by consumers (e.g. a posting that seeks a specific item). The vendors can then respond to the posting via the service in order to sell the item.

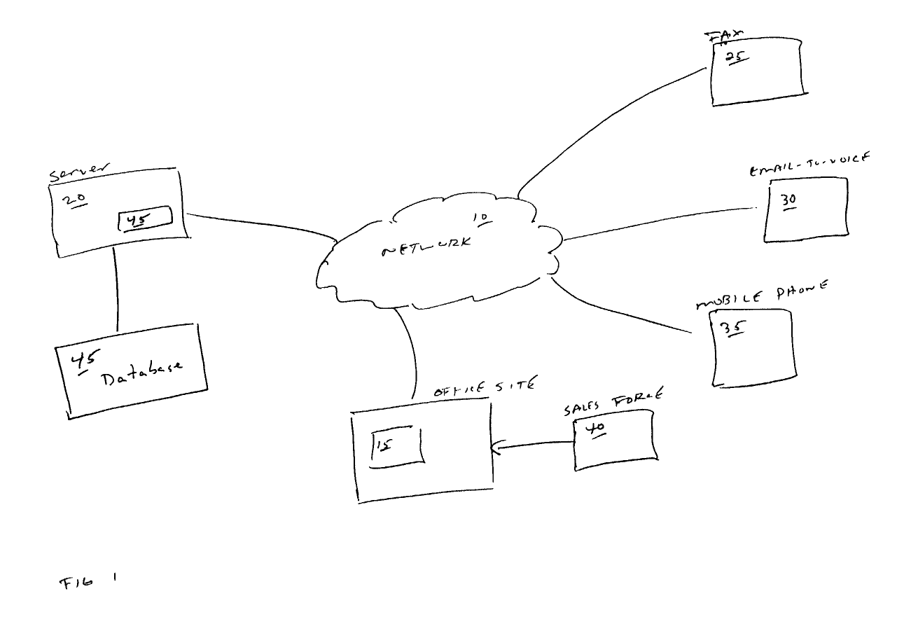

The service can be implemented in a variety of embodiments. FIG. 1 illustrates an exemplary diagram of the system in the present invention. The system illustrated in FIG. 1 includes, for example, a network 10, a computer 15, a server 20, a fax 25, an email-to-voice device 30, a mobile phone 35 and a sales force 40. Network 10 is, for example, a communication network or transmission medium which is capable of connecting any one of or all of the individual parts of the system. Network 10, such as an internet, is the medium through which information is transmitted in order for devices, components and the like to communicate with one another. While network 10 is used in the preferred embodiment, one having ordinary skill in the art will recognize that any means of communication can be used. For example, a point-to-point or dial-up connection could be used. Server 20 stores, for example, a database of information and is continually updated to include new information and to remove old information as necessary. Of course, a database 45 can be attached to server 20 for storage. Server 20 can also store web pages used to produce an on-line store that is accessible by other devices and components connected to network 10. For example, computer 15 can be accessed by a user in order to add information to the existing database 45 that has been supplied by vendors. Vendors can supply information directly to server 20 by accessing the web pages included therein, after having properly registered with the service. Similarly, consumers can access server 20 to post messages. A more detailed description may be found below.

In the preferred embodiment of the invention, vendors first register with the service. Once registered, vendors can supply information to the database 45 via inputting information onto the web page or by using salespersons in sales force 40. Inputting information onto web pages is performed as readily understood by one having ordinary skill in the art. For example, users can access the web pages using computer 15, call up web pages located on server 20, and input information that is sent to and stored on server 20. Alternatively, for users (e.g. vendors or consumers) that do not have on-line access, information for storage in database 45 can be collected by salespersons in sales force 40. Once information is stored in the database 45, the information can be disseminated in a variety ways including, but not limited to, facsimile 25, email-to-voice device 30, mobile phone 35 satellite or radio frequency. This ensures that vendors and/or consumers (e.g. those that do not have on-line access) are able to access the database 45 of information supplied by the service, irrespective of their ability to connect on-line.

The process by which a consumer can access information from or add information to the database 45 will now be described. Initially, users (e.g. consumers) can log-on to the service. Non-registered members can sign-in prior to log-on. The users register just like any other registration process. User name, address, credit cart information, preferred shipping methods, etc. can be acquired during registration. Once registered, a user need only identify him/herself in order to continue and access the service.

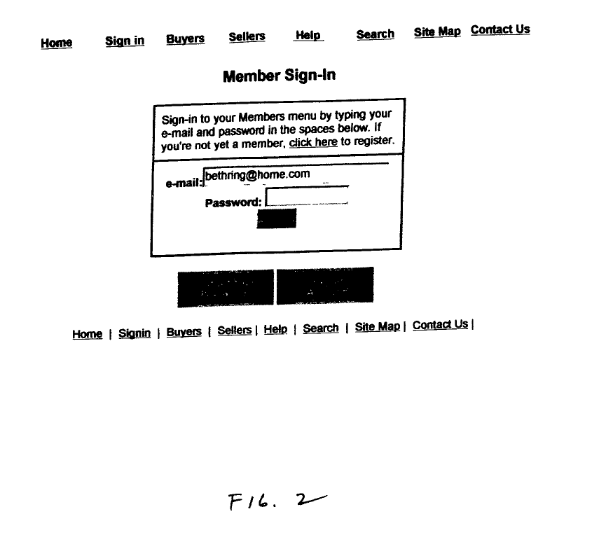

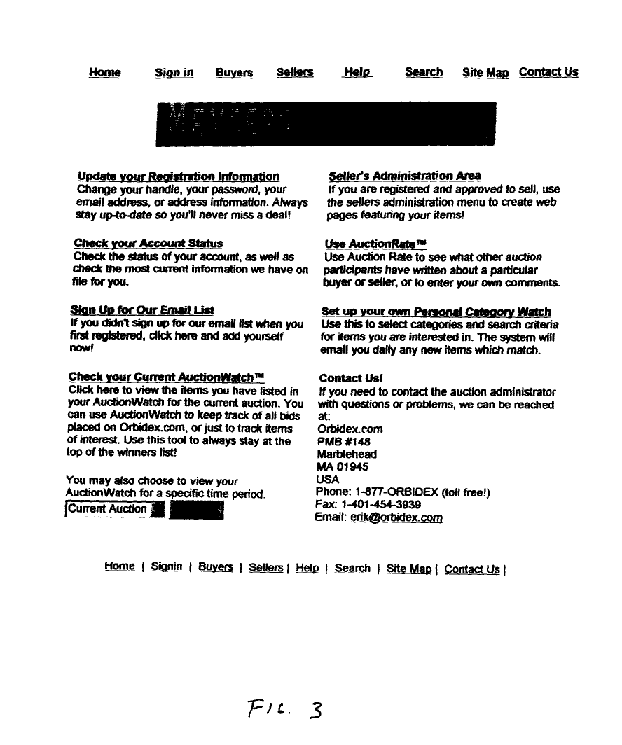

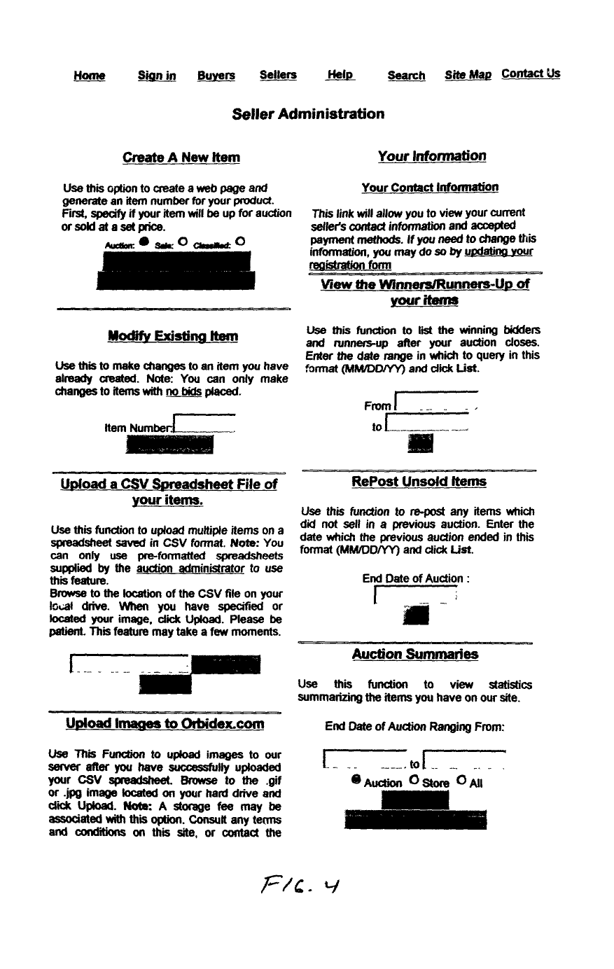

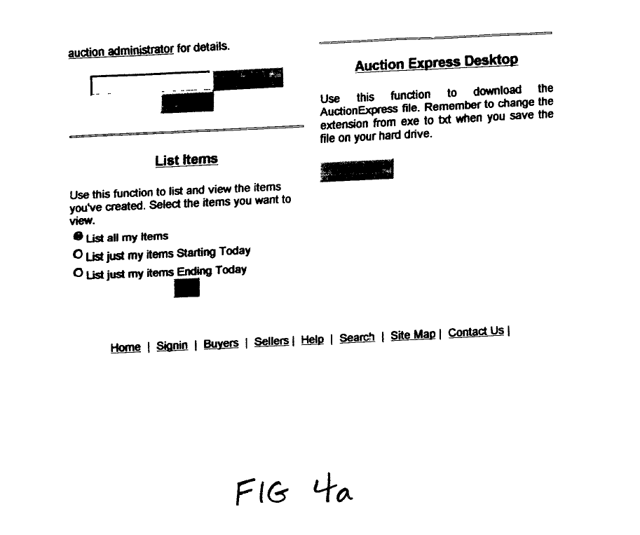

Specifically, a member sign-in page, as illustrated in FIG. 2, allows users to register. Once registered, the user can access a variety of services including, for example, TM account services, registration information, email list, auctionrate™, seller's administration, etc. (see, for example, FIG. 3). Users can search, view buyer information, view seller information, etc. For example, when a user clicks on “Seller's Administration Area” (see, for example, FIGS. 4 and 4a), one of the options presented is to select “Create a New Item”. In this regard, users can create an item to be posted for sale on the appropriate web page. For example, if a user wants to post an antique clock for sale, the user can create an item called “antique clock”, and specify that it be placed in the category “Antiques”. Other users can then view the list of items that are posted by simply going the “Antiques” category, and viewing the list of displayed items. Similarly, users can modify items already registered, as well as upload images of the items posted. One having ordinary skill in the art will recognize that numerous options may be presented to users.

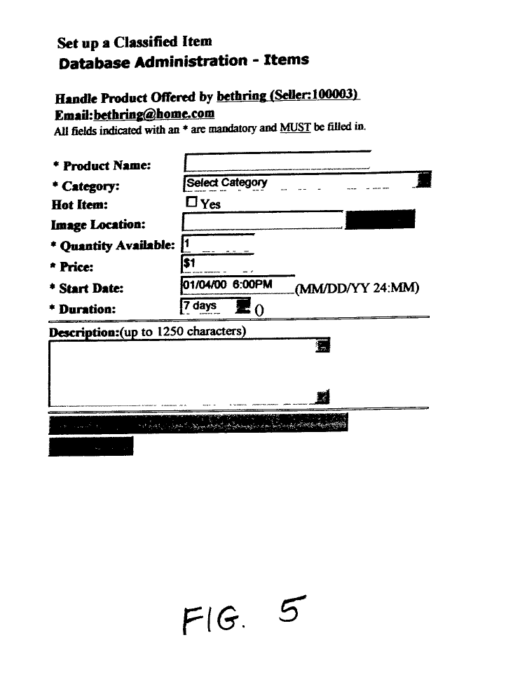

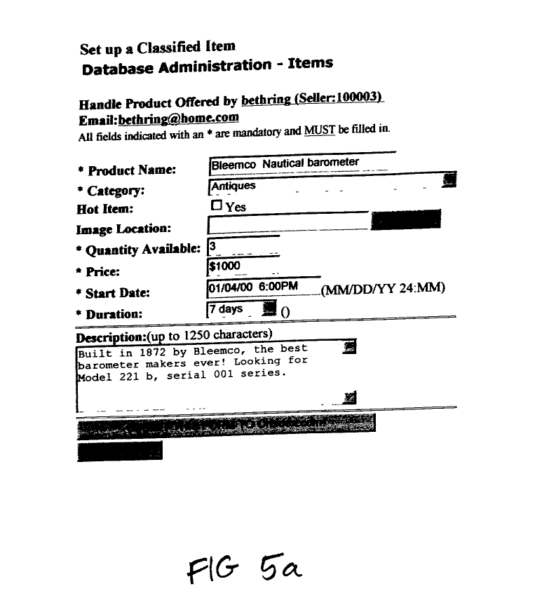

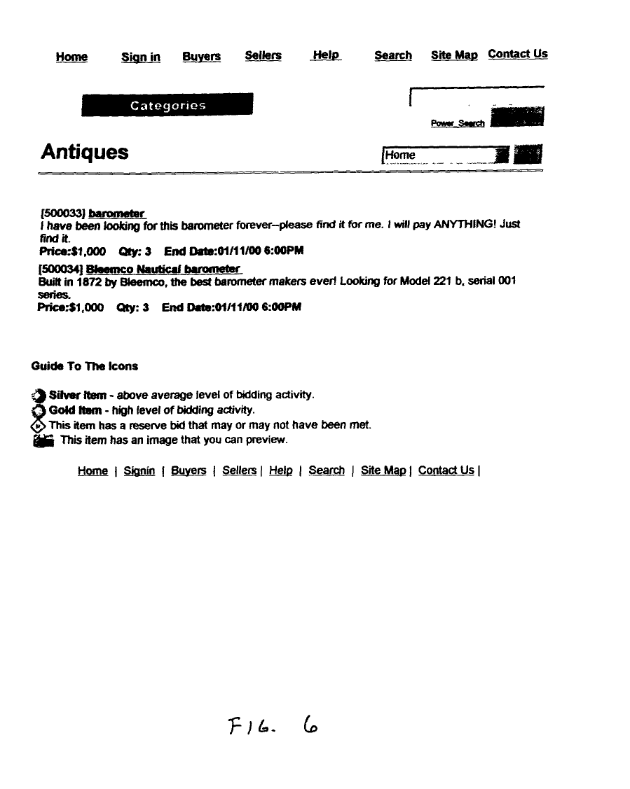

Users can also search for a specific item in the database 45. In order to do this, a user would be prompted with a screen similar to the one entitled “Set up a Classified Item”, as illustrated in FIGS. 5 and 5a. The user would be prompted to enter, for example, a product name, category, image, quantity, price, start date, duration and a description. Essentially, users can input any information that may be of value in ultimately locating the desired item. For example, a user may be in search of a Model-T Ford (an antique automobile). In order to place an item in the database, the user could select a category such as “Antiques” and then upload an image of the automobile for display by other consumers and vendors, or simply input a description of the antique. Vendors that do not have access to on-line services are delivered the information via the various forms of transmission (e.g. fax, mobile phone, mail, etc.), as illustrated in FIG. 1. In this regard, the vendor never has to register with services on-line, nor does it have to access the system on-line. Rather, when a user inputs or requests (see, for example, FIG. 6) an item, vendors are selected (e.g. matching criteria of the item description with information about specific vendors businesses) and transmitted the requested item. As stated above, transmission of the item information to the vendor can be, for example, by fax, telephone, mail or any other method understood by one of skill in the art. Of course, vendors can access the system and view items posted by consumers (users) or the system can generate a list of items specific to individual vendors (e.g. aggregate items by category or otherwise) and post or send the list to the vendor(s), as well understood in the art.

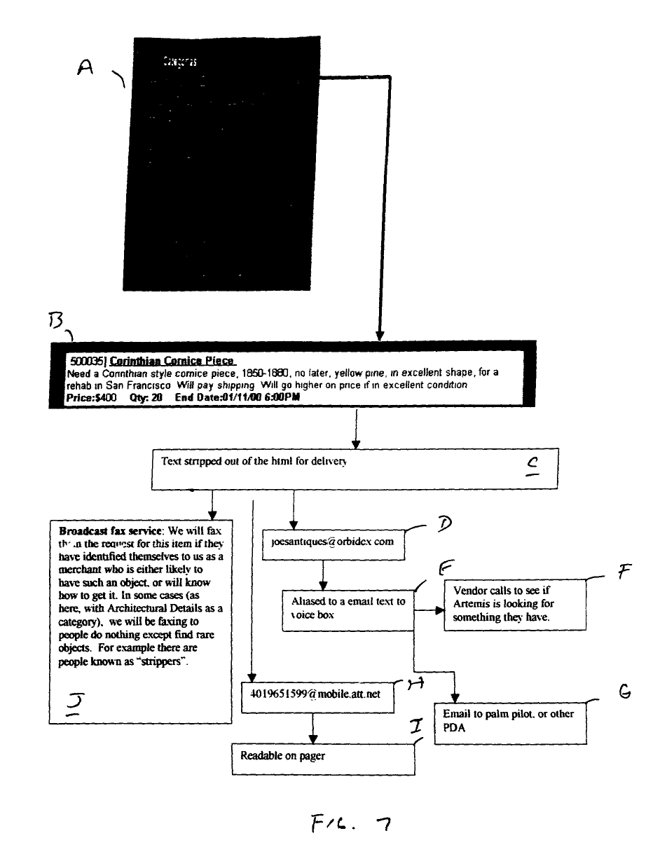

Once the information is submitted, it is sent via network 10 to server 20 and stored in the database 45. The database 45 can reside on the server 20 with the web pages, or can reside on a separate server. The database 45 can then be accessed to display information in the database 45. Retrieval of the information in the database 45 is accessible, for example, by personal computer 5 located within the office site. As illustrated in the FIG. 7, the information submitted on the “Set up a Classified Item” page (FIGS. 5 and 5a) is modified (e.g. stripped) to a particular format for display on the service site, and/or broadcast to relevant vendors. More specifically (referring to FIG. 7), a category is selected (A) and information about an item is stored to database 45 in a particular format, for example, as illustrated (B). This information can be posted and displayed on the site, or can be manipulated and sent to select vendors. When information is sent to vendors that are off-line (e.g. do not have access to the network 10), the information is manipulated such that it accommodates the device being sent to and conforms to best utilize the medium over which it is being transmitted. For example, a message sent to a pager will first be “stripped” of unnecessary text and displayed on the pager as, for example, a simple message to contact the system or as a full text message on the pager (H, I). Alternatively, the message can be faxed (J) or sent via email or voicemail (D-G), or using any other technique well known in the art.

Off-line Buyers Searching for Information On-line, or Off-line, via Indexing “bots”

The present invention, as described above, collects information off-line about objects requested by users. Collection can occur, for example, by a salesperson entering data into a computer for later synchronization with the buyers search function. Transmission of data from salesperson to database may occur by fax transmissions, automated via OCR, a phone messaging system that uses voice recognition software (or transcription), mailed in preformatted data entry sheets, etc. Information about the object requested will be used to launch a search spider to search the web for matches to the query. The search bot, or “spider” will use the search query fields to customize the script, or executable, that will be responsible for conducting a targeted web based search. The matches that the bot finds will be used to produce a formatted result, ready for transmission to the off-line community via various means, for example, text to fax, text to email to cell phone messaging, text to voice synthesis to email box for retrieval and various other methods. The result may include on-line matches (items available online) or off-line matches (items available from submissions via various off-line means of querying).

Offline Buyers Searching for Information Online, via Metasearches

The present system, as described above, collects information off-line about objects requested by a user. Collection can occur, for example, by a salesperson entering data into a computer for later synchronization with the buyers search function. Transmission of data from salesperson to database may occur by fax transmissions, automated via OCR, a phone messaging system that uses voice recognition software (or transcription), mailed in preformatted data entry sheets, etc. Information about the object requested will be used to insert values into a metasearch engine, which will then query all of the web search enabled databases that have a high likelihood of having such items. In the case that such sites will make their databases available directly, the metasearch function might make direct connections to the database to conduct the search (for example through XML, DLL's, direct ODBC connections, and the like). The matches that the metasearch finds will be used to produce a formatted result, ready for transmission to the off-line community via various means, for example, text to fax, text to email to cell phone messaging, text to voice synthesis to email box for retrieval and various other methods. The result may include on-line matches or off-line matches.

Off-line Buyers Searching for Information On-line, or Off-line, via Indexing

Information is collected off-line about objects requested by a user. Collection can occur, for example, by a salesperson entering data into a computer for later synchronization with the buyers search function. Transmission of data from salesperson to database may occur by fax transmissions, automated via OCR, a phone messaging system that uses voice recognition software (or transcription), mailed in preformatted data entry sheets, etc. Information about the object requested will be used to search the system index, which will be part of the system database. The index will be kept current via indexing bots (“spiders”) and via submission for indexing by direct data entry by on-line sellers (for example, Yahoo™). Submission to the index by off-line sellers can also be done via non electronic means (previously mentioned).

Off-line Buyers Searching for Information On-line, or Off-line, via Data Synchronization

Members of the off-line community often do not have Internet connections, but do have computers. Searches for on-line goods can be established, in these cases, via an application that receives the query for goods, and periodically dials up via a POTS line to establish a direct connection to the system database, at which point matches can be found, or searches conducted through normal search means, for example: inserting the query language into search bot variables (previously discussed), local database searches, etc. The results can be delivered via the connection to the offline computer, or via other non-Internet means (text to voice, text to fax, etc).

Although the present invention has been described in detail, it is clearly understood that the same is by way of illustration and example only and is not to be taken by way of limitation.

We claim:

1. A method of gathering data on-line for use off-line, comprising:
collecting data from users off-line and storing the data in a storage unit; and
sending the data collected off-line to users on-line.

2. The method of claim 1, wherein the data is collected from a web page accessible by the users on-line, and
data sent to the users off-line is manipulated before sending such that the data conforms to a device receiving the data.

3. A method of communicating data to users off-line using the data stored on-line, comprising:
storing data in a database; and
delivering the data stored in the database to users, such that the users receive the information without going on-line to access the database.

4. The method of claim 3, wherein the data includes a request for an item to be submitted to a vender off-line.

5. The method of 3, further comprising:
manipulating the data to place it in a format conforming to a device receiving the data.

6. A method of searching for an object using a intermediary, comprising:
providing an interface for a user to request the objects; and
sending the request to users off-line, enabling the users off-line to search for the requested objects.

7. The method of claim 6, further comprising:
storing the request in a database;
selecting users to send the data to based on the requested data; and
notifying the user on-line of the results of the search.

8. The method of claim 7, wherein selecting includes correlating data based on category and business type information

9. A method of shopping on-line using retailers/vendors off-line, comprising:
searching a database including data having user requests stored therein; and
sending the data, manipulated to conform with a receiving device, such that a search based on the user requests is conducted by a selected retailer/vendor.

10. The method of claim 9, further comprising:
forwarding results of the search for posting on-line.

11. A system for gathering data on-line for use off-line, comprising:
a database collecting data from users off-line; and
a server accessing the data in the database and sending the data to users on-line.

12. A system for shopping on-line using retailers/vendors off-line, comprising:
a database storing data including user requests and retailers/vendors; and
a server matching the user requests and retailers/vendors data, and sending the user request to the matched retailers/vendors such that a search based on the user requests is conducted by a selected retailers/vendors.

13. The system of claim 12, wherein results of the search by the retailers/vendors are posted on-line.
